(19) United States
(12) Patent Application Publication
(10) Pub. No.: US 2026/0304162 A1
(43) Pub. Date: Oct. 1, 2026

(54) AUTOMATICALLY AND DYNAMICALLY COORDINATING LOAD BALANCERS IN A COMPUTER NETWORK

(71) Applicant: Red Hat, Inc., Raleigh, NC (US)

(72) Inventor: Trilok Mallikarjunappa Geer, Bangalore (IN)

(73) Assignee: Red Hat, Inc., Raleigh, NC (US)

(21) Appl. No.: 19/090,586

(22) Filed: Mar. 26, 2025

(51) Int. Cl. H04W 24/04; H04W 28/08

(52) U.S. Cl. CPC H04W 24/04; H04W 28/09

(57) ABSTRACT

In some examples, a system can receive sets of metric values from a first load balancer and a second load balancer in a computer network. The system can detect an anomaly with respect to the first load balancer based on the sets of metric values. The system can determine, based on the anomaly, a first action to execute with respect to the first load balancer. The system can also determine a second action to execute with respect to the second load balancer. The system can then execution the first action and the second action to help resolve the anomaly.

### TECHNICAL FIELD

The present disclosure relates generally to load balancing in a computer network. More specifically, but not by way of limitation, this disclosure relates to automatically and dynamically coordinating load balancers in a computer network.

### BACKGROUND

In distributed computer networks such as cloud systems, load balancers are often chosen as part of solutions to ensure availability, reliability, scalability, and security for application services. A load balancer can distribute network traffic to a group of connected application services, such as microservices and serverless functions. Some distributed networks include have multiple load balancers that help distribute incoming traffic in various ways.

In some cases, load balancers can be used to facilitate ingress sharding in a distributed computer network. Ingress sharding is also sometimes referred to as “traffic route sharding”. Ingress sharding is a technique where incoming network traffic from multiple entry points is distributed across multiple routers or ingress controllers, effectively splitting the incoming load and allowing for better management of different types of traffic within a network. In this context, the load balancers can serve as the ingress controllers.

### BRIEF DESCRIPTION OF THE DRAWINGS

FIG. 1 shows a block diagram of an example of a system for automatically and dynamically coordinating load balancers in a computer network, according to some aspects of the present disclosure.

FIG. 2 shows an example of rules that map anomalies to actions, according to some aspects of the present disclosure.

FIG. 3 shows examples of rules, actions, and commands, according to some aspects of the present disclosure.

FIG. 4 shows a block diagram of an example in which the load balancers are in different hierarchical levels of a computer network, according to some aspects of the present disclosure.

FIG. 5 shows a block diagram of an example of a system for automatically and dynamically coordinating load balancers in a computer network, according to some aspects of the present disclosure.

FIG. 6 shows a flowchart of an example of a process for automatically and dynamically coordinating load balancers in a computer network, according to some aspects of the present disclosure.

### DETAILED DESCRIPTION

A computer network may include multiple load balancers from the same or different vendors. Depending on the deployment scenario, load balancers can be utilized for ingress sharding and distributing traffic among application service groups. If the load balancers are not properly optimized (e.g., configured or managed), network performance can degrade. For instance, network resources may be underutilized or inefficiently allocated, resulting in latency, failures, and other performance issues. Therefore, ensuring that load balancers are effectively optimized is critical for achieving and maintaining efficient network operation. However, in conventional deployments, load balancers typically lack the ability to communicate or coordinate with one another. This lack of coordination makes it difficult and time-consuming to configure them for efficient performance and ingress sharding. Furthermore, the performance of a particular load balancer configuration is often influenced by the prevailing network conditions. Since these conditions are dynamic and subject to change, a configuration that works well at one moment may become inefficient at another. As a result, the traditional practice of statically configuring load balancers can lead to significant inefficiencies as network conditions evolve over time.

Some examples of the present disclosure can overcome one or more of the abovementioned problems by providing an automated system for monitoring and configuring multiple load balancers as a wholistic group to improve (e.g., optimize) performance in a computer network. To determine whether the load balancers in the computer network need adjustment, the automated system can receive multiple metric values from each of the load balancers. Examples of such metric values can include load-balancer data size-buffers, throughput, connection rate, CPU and memory usage of the load balancer application, latency, error rate, session persistence, request queue length, resource limits, load-balancer node metrics, etc. Based on the metric values from one or more of the load balancers, the system can automatically adjust the configurations of two or more of the load balancers to improve network performance. Adjusting the configuration of a load balancer can involve changing one or more of its settings. These adjustments can be performed dynamically, in real time. In this way, the automated system can continually monitor the load balancers performances and dynamically adjust the configurations of multiple load balancers as a wholistic group to improve network performance. Treating the load balancers as a group and optimizing them together can achieve better performance than only adjusting a single load balancer. The system can be used for both hierarchical- and lateral-load-balancer group deployments, which may involve load balancers from multiple vendors in a single group deployment.

As an example, the automated system can receive values for performance metrics from load balancers. The system can apply a default set of rules to the metric values to identify potential anomalies. Alternatively, a user can specify which load balancer metrics to monitor and provide custom performance metrics for load balancers to be monitored by the system. Upon detecting an anomaly, the system generates a list of recommended actions designed to address the issue. These recommended actions are determined based on a default set of rules. Alternatively, the user can override the default set of rules and provide custom rules that map recommended actions to anomalies. The recommended actions are executable to change the behavior of the group of load balancers. If any conflicts arise among the proposed actions, the system resolves them by applying conflict resolution rules.

Once the set of recommended action is finalized, the system converts the actions into interface requests containing specific commands and transmits them to the appropriate load balancers. This process can be facilitated by plugins that are tailored to interact with different types of load balancers, accommodating variations in vendor specifications, settings, and operational properties of the load balancers. The respective load balancers process these interface requests and reconfigure themselves according to the provided commands. This reconfiguration can address the detected anomaly to enhance network performance. By enabling the coordinated reconfiguration of multiple load balancers, the system effectively mitigates identified anomalies, improving network efficiency.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

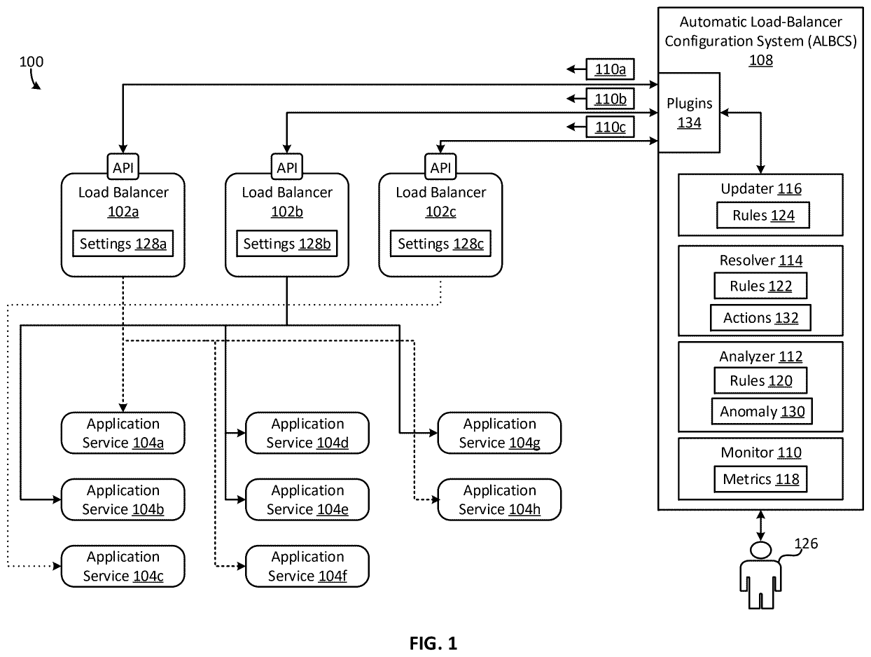

FIG. 1 shows a block diagram of an example of a system 100 for automatically and dynamically coordinating load balancers 102a-c in a computer network, according to some aspects of the present disclosure. In this example, the system 100 includes three load balancers 102a-c, though in other examples there may be more or fewer load balancers. The load balancers 102a-c may be of the same type or different types, and the load balancers 102a-c may be in the same hierarchical level or different hierarchical levels of the computer network.

The load balancers 102a-c can each be configured to perform a load balancing function and/or an ingress sharding function with respect to a corresponding group of application services. Examples of the application services user application services and merchant application services. In the example shown in FIG. 1, load balancer 102a can perform load balancing and/or ingress sharding with respect to application services 104a, 104f, and 104h. Load balancer 102b can perform load balancing and/or ingress sharding with respect to application services 104b, 104d, 104e, and 104g. Load balancer 102c can perform load balancing and/or ingress sharding with respect to application service 104c. Thus, the load balancers 102a-c may be responsible for performing load balancer and/or ingress sharding with respect to the same number of applications services as one another or different numbers of application services as one another.

The load balancers 102a-c can each have respective settings that control their operation. Load balancer 102a can have a first group of settings 128a, load balancer 102b can have a second group of settings 128b, and load balancer 102c can have a third group of settings 128c. Because the load balancers 102a-c may be of the same type or different types (e.g., different vendors, versions, or etc.), they may have the same settings or different settings as one another. For example, load balancers 102a may have at least one setting that is different from load balancers 102b. Additionally, the load balancers 102a-c may have the same setting values or different setting values as one another. For example, load balancers 102a-b may have the same value for a particular setting or different values for that setting. Examples of the settings can include (i) an access control list to allow for a specific host and/or path; (ii) a use backend rule to forward a path-specific traffic to a selected backend server; (iii) a balance rule to adjust the load-balancing algorithm based on traffic patterns, request types, and backend server behavior; and (iv) a redirect rule to redirect traffic based on path, domain, and/or scheme.

The load balancers 102a-c can also include interfaces, such as application programming interfaces (APIs) or user interfaces. The interfaces can be used to configure the load balancers 102a-c. For example, the interfaces can be configured to receive commands to adjust one or more of the settings 128a-c of the load balancers 102a-c. Such commands may be issued to the load balancers 102a-c by users or software. Through the interfaces, the load balancers 102a-c can be dynamically reconfigured while they are running, without requiring a shutdown.

In this example, the system 100 also includes an automatic load-balancer configuration system (ALBCS) 108. The ALBCS 108 can include a monitor 110 that receives values for a selected group of metrics 118 (e.g., performance metrics) from each of the load balancers 102a-c. For example, a user 126 can select the group of metrics to be monitored from among a larger set of metrics. The selected group of metrics can include two or more metrics. The monitor 110 can then obtain values for the selected group of metrics 118 from each of the load balancers 102a-c. For instance, the monitor 110 can receive a first set of values for the selected group of metrics from the first load balancer 102a, a second set of values for the selected group of metrics from the second load balancer 102b, and a third set of values for the selected group of metrics from the third load balancer 102c. Examples of the metrics can include (i) throughput, which can be the amount of data passing through a load balancer; (ii) connection rate, which can be the rate of new connections or number of concurrent connections; (iii) CPU usage of the load balancing application; (iv) memory usage of the load balancing application; (v) latency in processing and forwarding traffic through the load balancer; (vi) error rate, which can be the rate of errors and anomalies such as connection errors/failures, timeouts, and protocol-specific errors; (vii) session persistence, which can be the number of sessions persisted over time; (viii) backend service health monitoring such as CPU, memory, disk usage, request processing latency, etc.; (ix) backend service response rate; (x) request queue length; (xi) resource limits such as maximum number of concurrent sessions (or connections), maximum open files, etc.; and (xii) load-balancer node metrics, such as their resource usage (e.g., CPU, memory, and storage), node network throughput, node-level latency due to noisy neighbor problem, etc. After receiving the sets of metric values, the monitor 110 can transmit some or all of the metric values to an analyzer 112 for evaluation.

The analyzer 112 can detect one or more anomalies 130 based on the metric values. The anomalies 130 can be performance anomalies, which are anomalies in the performance of one or more of the load balancers 102a-c. In some examples, the analyzer 112 can detect the anomalies 130 by applying a first set of rules 120. The first set of rules 120 may be provided by one or more users, such as the user 126. The first set of rules 120 can include thresholds, conditional expressions, value ranges, etc., that may define an anomaly condition.

As one example of a rule, if a value of one of the selected metrics meets or exceeds a threshold, an anomaly 130 can be detected. As another example of a rule, if a value of one of the selected metrics is below the threshold, an anomaly 130 can be detected. In some rules, multiple values for multiple metrics may be evaluated to detect an anomaly 130. For example, if at least two metric values meet or exceed the same threshold or different respective thresholds, an anomaly 130 can be detected. As another example, if a first metric value is above a first threshold and a second metric value is below a second threshold, an anomaly 130 can be detected. As still another example, if at least two metric values are below the same threshold or different respective thresholds, an anomaly 130 can be detected. Some rules may involve specific values or value ranges for the metrics. For example, if a metric has a particular value or falls within a particular value range, an anomaly 130 can be detected. As another example, if a first metric value falls in a first range and a second metric value falls in a second range, which may be the same as or different from the first range, an anomaly 130 can be detected. These and other rules can be defined in the first set of rules 120 to detect various different types of anomalies 130.

In some examples, machine learning can be used to identify the anomalies 130 additionally or alternatively to the first set of rules 120. For example, a trained neural network can be applied to the first, second, and/or third set of metric values. The trained neural network may have been pretrained using labeled training data to identify anomalies based on metric values. The trained neural network can analyze the input metric values for specific patterns or other indicia of anomalies 130. If the trained neural network detects on or more anomalies based on the input metric values, the trained neural network can generate an output indicating the one or more anomalies 130. In some examples, the trained neural network can learn to apply some or all of the first set of rules 120 to detect the anomalies 130. In these examples, some or all of the first set of rules 120 may be learned through the training process (e.g., rather than being user-supplied).

If one or more anomalies are detected by the analyzer 112, the analyzer 112 can indicate the anomalies 130 to a resolver 114. The resolver 114 can determine actions 132 based on the one or more anomalies 130. The actions 132 can be configured to help mitigate the one or more anomalies 130. An action 132 can include an adjustment to at least one setting value of at least one load balancer. To mitigate single anomaly, the system may need to execute multiple actions 132 to adjust multiple setting values for a single load balancer and/or multiple setting values across multiple load balancers.

The resolver 114 can apply a second set of rules 122 to determine which action(s) 132 to perform to mitigate a given anomaly. In some examples, the second set of rules 122 can be provided be one or more users, such as user 126. An action can include a predefined set of steps to be followed to achieve remediation. Examples of actions can include initiating high availability for a load balancer (e.g., to address node faults and scaling problems), traffic normalization, throughput correction (e.g., correction for latency anomalies), and error-path correction (e.g., correction for protocol errors).

In some examples, machine learning can be used to determine the actions 132 additionally or alternatively to the second set of rules 122. For example, a trained neural network can be applied to the one or more anomalies. The trained neural network can be different from the trained neural network of the analyzer 112. The trained neural network may have been pretrained using labeled training data to identify actions based on anomalies. The trained neural network can analyze the input anomalies and generate an output indicating the one or more actions 132. In some examples, the trained neural network can learn to apply some or all of the second set of rules 122 to determine the actions 132 based on the anomalies 130. In these examples, some or all of the second set of rules 122 may be learned through the training process (e.g., rather than being user-supplied).

In some examples, two or more of the determined actions 132 may conflict with one another. If so, the resolver 114 can apply conflict resolution rules to help resolve the conflict. The conflict resolution rules can weight or prioritize certain actions over others. For instance, the resolver 114 can be detect mutually exclusive actions and skip the lower-priority action to prevent a conflict. In some examples, the conflict resolution rules can sequence the determined actions in a certain order-e.g., to prevent a conflict or otherwise facilitate their successful implementation. After arriving at the final action(s), the resolver 114 can indicate the final action(s) to an updater 116.

The updater 116 can translate the one or more actions 132 into one or more interface requests 110a-c that implement the actions 132. For example, the updater 116 can translate a single action into one or more interface requests 110a-c for one or more of the load balancers 102a-c. Each interface request can include at least one command configured to modify at least one setting value of the corresponding load balancer. For example, the interface request 110a can include at least one command to modify at least one value of the settings 128a of the load balancer 102a. Interface request 110b can include at least one command to modify at least one value of the settings 128b of the load balancer 102b. And interface request 110c can include at least one command to modify at least one value of the settings 128c of the load balancer 102c. The updater 116 can transmit the respective interface requests 110a-c to the respective interfaces of the load balancers 102a-c to effectuate the modifications to the settings 128a-c.

In some examples, the updater 116 can use plugins 134 to translate the actions 132 into the interface requests 110a-c and/or communicate with the load balancers 102a-c. For example, the updater 116 can use a first plugin to translate a first action into a first interface request 110a for the first load balancer 102a and communicate with the first load balancer 102a. The updater 116 can use a second plugin to translate a second action into a second interface request 110b for the second load balancer 102b and communicate with the second load balancer 102b. The updater 116 can use a third plugin to translate a third action into a third interface request 110c for the third load balancer 102c and/or otherwise interact with the third load balancer 102c. The first, second, and/or third plugins may be different from one another. This may be useful if the load balancers 102a-c require different request formats or commands than one another, for example because they are of different types than one another. Similarly, the interface requests 110a-c may be formatted differently from one another and/or involve different commands than one another to accommodate variations in the load balancers 102a-c. As one particular example, the first group of settings 128a may include a first setting and exclude a second setting, while the second group of settings 128b may include the second setting and exclude the first setting. In that example, the first interface request 110a may include a first command for modifying the first setting and exclude a second command for modifying the second setting, whereas the second interface request 110b may include the second command for modifying the second setting and exclude the first command for modifying the first setting.

The updater 116 and/or plugins 134 can rely on a third set of rules 124 to convert an action 132 to one or more interface requests 110a-c. In some examples, the third set of rules 124 may be provided by developers of the load balancers 102a-c or another entity. For instance, the third set of rules 124 may be part of a software development kit (SDK) provided by the vendors of the load balancers 102a-c. The third set of rules 124 may be used to perform reformatting operations. For example, the updater 116 and/or plugins 134 can use the rules 124 to change the format (e.g., syntax) of a command associated with the action 132—e.g., from a first format that is incompatible with load balancer 102a to second format that is compatible with the load balancer 102a. The interface request 110a can then be configured to include the reformatted command in the second format.

In some examples, the plugins 134 may be downloaded from one or more repositories. And, in some examples, the plugins 134 may be created by third parties, such as the vendors of the load balancers 102a-c or a community of developers. For instance, the plugins 134 may include SDKs of the vendors. The plugins 134 can include instructions for generating the interface requests 110a-c for the load balancers 102a-c. Through the plugins, the system can be extensible in that it can be used with an ever-increasing number of load balancers. As long as the appropriate plugin is created and installed, the ALBCS 108 may be able to interact with a given load balancer to implement the techniques described herein.

The load balancers 102a-c can receive the interface requests 110a-c via the interfaces and respond by modifying the values of their settings 128a-c as commanded. This can change the operation of the load balancers 102a-c in a way that helps mitigate the detected anomalies 130.

Through the above process, the ALBCS 108 can monitor the performance of the load balancers 102a-c, detect one or more anomalies in their performance, and remediate the anomalies. This remediation can be performed automatically and in real time, as the load balancers 102a-c are running. This process can run relatively continuously, allowing the settings 128a-c of the load balancers 102a-c to be dynamically adjusted over time (e.g., based on changing network conditions) to maintain high levels of network performance. Additionally, the ALBCS 108 can coordinate adjustments across multiple load balancers 102a-c as a unified group, enabling complex adjustments to combinations of load balancers that collectively improve overall network efficiency. This group-based approach can yield significantly better results than addressing each load balancer in isolation.

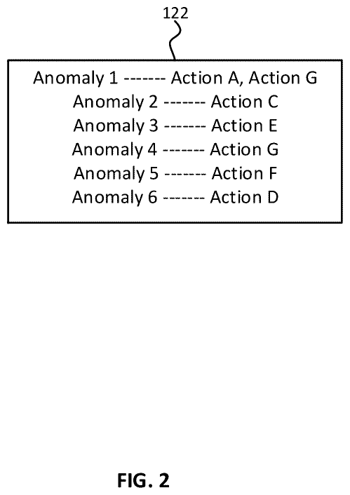

Turning now to FIG. 2, shown is an example of rules 122 that map anomalies to actions, according to some aspects of the present disclosure. As shown, each anomaly can be mapped to one or more actions. In this example, anomaly 1 is mapped to two actions, though it may be mapped to more or fewer actions in other examples. Additionally, anomalies 1 and 4 are mapped to the same action-action G. The other anomalies are mapped to different actions-action C, E, F, and D, respectively. Implementing each action may involve adjusting one or more setting values associated with one or more load balancers. For example, action A may involve adjusting a first setting value for a first load balancer and a second setting value for a second load balancer. The first setting value and the second setting value may or may not correspond to the same setting.

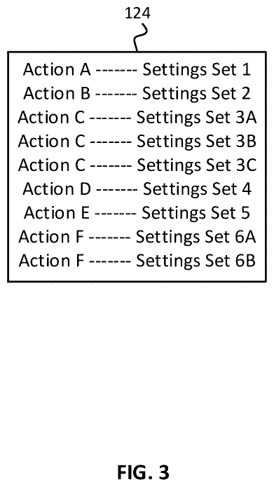

Turning now to FIG. 3, shown are examples of rules 302, actions 304, and commands 306, according to some aspects of the present disclosure. The rules 302 are for detecting anomalies. The rules 302 may be default rules provided by the system or custom rules provided by a user. In the first rule (“LB_computation”), the metric under evaluation is CPU usage. In the rule, that metric has a maximum limit of 100m, with a tolerance of 0.1. The rule is specifically assigned to Load Balancer A (“LB_A”), though a single rule may be assigned to multiple load balancers in other examples. In the second rule (“Service_error_rate”), the metric under evaluation is “http_protocol_error” and that metric has a maximum limit of 50. This rule is again assigned to Load Balancer A. In the third rule (“LB_request_queue”), the metric under evaluation is “lb_request_queue” and that metric has a maximum limit of 200M. The rule is assigned to Load Balancer B (“LB_B”). In the fourth rule (“Service_degraded”), the metric under evaluation is “health_check_port” and that metric has a maximum limit of 10 failures. This rule assigned to Service A (“Service_A”), which is not a load balancer but rather another kind of service.

The actions 304 indicate which actions to execute each time one of the rules 302 is triggered. Such a mapping of actions to rules can be provided by a user. As one example, the action “LoadBalancer_HA” is mapped to the rule LB_computation and the rule LB_request_queue, so that this action is executed each time either of those rules is triggered. The action “Normalize_LoadBalancer” is mapped to the rule LB_request_queue, so that this action is executed each time that rule is triggered. The action “Error_path_correction” is mapped to the rule service_error_rate and the rule service_degraded, so that this action is executed each time either of those rules are triggered. The actions 304 can also be predesignated certain priority levels, which can be used to resolve conflicts among the actions 304. For example, the action LoadBalancer_HA has been assigned a priority level of 10, while the action Normalize_LoadBalancer has been assigned a priority level of 5. Because LoadBalancer_HA is higher priority than Normalize_LoadBalancer, if there is a conflict between the two actions, LoadBalancer_HA may be executed before or instead of Normalize_LoadBalancer.

The commands 306 indicate which commands to execute to implement each action. Such a mapping of commands to actions can be provided by a user. As one example, the first set of commands (“LoadBalancer_HA”) indicates which commands to execute to perform the action LoadBalancer_HA. The first set of commands includes two commands-a first command to scale the ingress controller pods and a second command for sharding traffic. But in other examples, the first set of commands may contain more or fewer commands. In this example, the first and second commands are both load-balancer agnostic. They are commands for kubectl, which is a command line tool for Kubernetes, rather than for any specific load balancer. The load balancers may be executing in the Kubernetes environment. In other examples, the first set of commands can additionally or alternatively include load-balancer-specific commands to be issued to the interfaces of one or more load balancers.

The commands 306 also include a second set of commands (“Normalize_LoadBalancer”). The second set of commands contains two commands-a first command corresponding to a first ingress controller application (e.g., a first load balancer) and a second command corresponding to a second ingress controller application (e.g., a second load balancer). But in other examples, the second set of commands may contain more or fewer commands. Both the first and second commands are associated with sharding traffic. Like the first set of commands, the second set of commands are load-balancer agnostic. But in other examples, the second set of commands can additionally or alternatively include load-balancer-specific commands to be issued to the interfaces of one or more load balancers.

In some examples, the system can translate (e.g., using a plugin) one or more of the commands associated with an action from a load-balancer agnostic format to a load-balancer-specific format. Additionally, in some examples the system can translate (e.g., using a plugin) one or more of the commands associated with an action from a first load-balancer-specific format to a second load-balancer-specific format, depending on which load balancer is to execute the command.

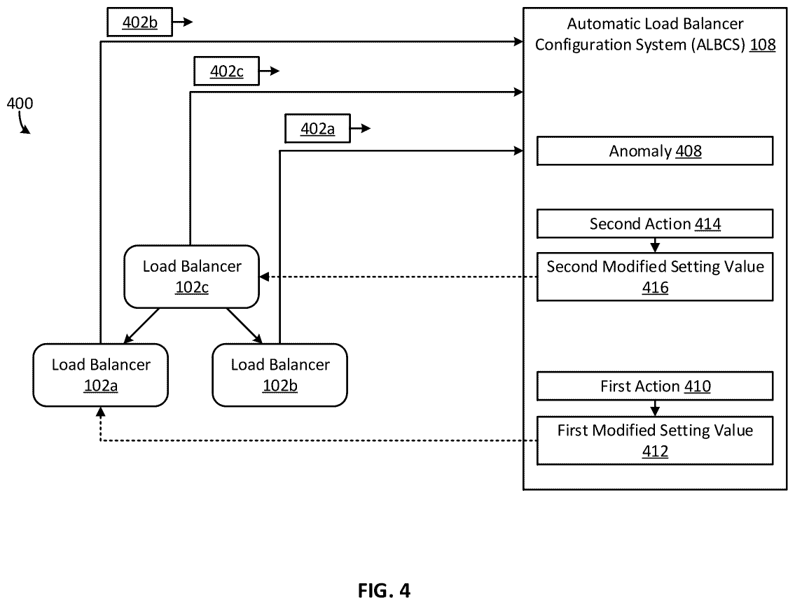

Turning now to FIG. 4, shown is a block diagram of an example in which the load balancers 102a-c are in different hierarchical levels of a computer network 400, according to some aspects of the present disclosure. In this example, the load balancer 102c is a parent of the load balancers 102a-b, and load balancers 102a-b are children of load balancer 102c. In this arrangement, load balancer 102c can balance traffic among load balancers 102a-b, which in turn can balance traffic to respective groups of application services (not shown for simplicity).

The system shown in FIG. 4 can operate similarly to that of FIG. 1. In particular, the ALBCS 108 can receive sets of metric values 402a-c from the load balancers 102c. Based on the sets of metric values 402a-c, the ALBCS 108 can detect an anomaly 408. Based on detecting the anomaly 408, the ALBCS 108 can determine a first action 410 to perform to help resolve the anomaly. The ALBCS 108 may also determine a second action 414 to perform to help resolve the anomaly. The ALBCS 108 can implement the first action 410 by determining a first modified setting value 412 for the load balancer 102a and configuring the load balancer 102a with the first modified setting value 412. A modified setting value is a change to a current value of a setting. The ALBCS 108 can also implement the second action 414 by determining a second modified setting value 416 for the load balancer 102c and configuring the load balancer 102c with the second modified setting value 416. This collection of modifications may mitigate (e.g., reduce the effect of or eliminate) the anomaly 408.

While the example shown in FIG. 4 shows load balancers in different levels of a hierarchy being reconfigured to mitigate an anomaly, in other examples load balancers in the same level of the hierarchy can additionally or alternatively be reconfigured to mitigate the anomaly. For example, the ALBCS 108 can determine a third action to perform to help resolve the anomaly. The ALBCS 108 can then implement the third action by determining a third modified setting value for the load balancer 102b and configuring the load balancer 102b with the third modified setting value. The particular combination of load balancers that needs to be reconfigured will depend on the detected anomaly.

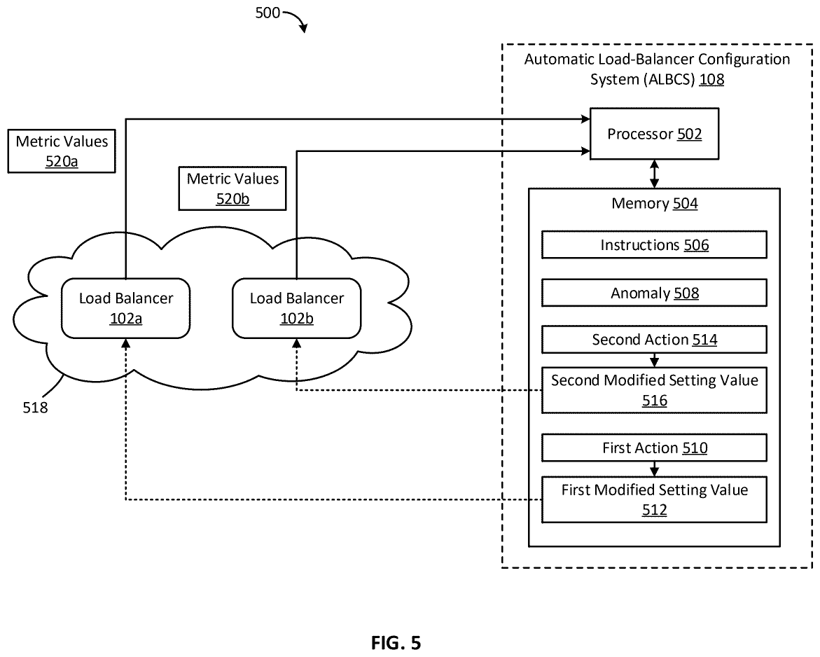

Turning now to FIG. 5, shown is a block diagram of an example of a system 500 for automatically and dynamically coordinating load balancers 102a-b in a computer network 518, according to some aspects of the present disclosure. The system 100 includes a processor 502 communicatively coupled to a memory 504. The processor 502 and memory 504 may be included in the ALBCS 108. The ALBCS 108 may or may not be part of the computer network 518. For instance, the ALBCS 108 may be external to the computer network 518, and access may be provided as a subscription service in some examples.

The processor 502 can include one processing device or multiple processing devices. Non-limiting examples of the processor 502 include a Field-Programmable Gate Array (FPGA), an application-specific integrated circuit (ASIC), a microprocessor, or any combination of these. The processor 502 can execute instructions 506 stored in the memory 504 to perform operations, such as any of the operations described above with respect to the ALBCS 108. In some examples, the instructions 506 can include processor-specific instructions generated by a compiler or an interpreter from code written in any suitable computer-programming language, such as C, C++, C#, Python, or Java.

The memory 504 can include one memory device or multiple memory devices. The memory 504 can be volatile or non-volatile, such that the memory 504 retains stored information when powered off. Non-limiting examples of the memory 504 include electrically erasable and programmable read-only memory (EEPROM), flash memory, or any other type of non-volatile memory. At least some of the memory device can include a non-transitory computer-readable medium from which the processor 502 can read the instructions 506. A computer-readable medium can include electronic, optical, magnetic, or other storage devices capable of providing the processor 502 with computer-readable instructions or other program code. Non-limiting examples of a computer-readable medium can include magnetic disks, memory chips, ROM, random-access memory (RAM), an ASIC, a configured processor, optical storage, or any other medium from which a computer processor can read the instructions 506.

In some examples, the processor 502 can execute the instructions 506 to perform one or more operations. For example, the processor 502 can receive a plurality of sets of metric values 520a-b from a group of load balancers 102a-b deployed in a computer network 518. Each set of metric values can correspond to a respective load balancer in the group of load balancers 120a-b. The group of load balancers 120a-b includes a first load balancer 120a and a second load balancer 120b. The processor 502 can detect an anomaly 508 with respect to the first load balancer 102a based on the plurality of sets of metric values 520a-b. The processor 502 can determine, based on the anomaly 508, a first action 510 to execute with respect to the first load balancer 102a to help resolve the anomaly 508. The processor 502 can also determine a second action 514 to execute with respect to the second load balancer 102b to help resolve the anomaly 508. The processor 502 can then execute the first action 510 and the second action 514 to help resolve the anomaly 508.

To execute the first action 510 and the second action 514, the processor 502 can translate the first action 510 into one or more commands 512. The commands 512 may be issued to a command line interface of a container orchestration platform of the computer network 518, an interface of the first load balancer 102a, or a combination thereof. The processor 502 can also translate the second action 514 into one or more commands 516. The commands 516 may be issued to a command line interface of a container orchestration platform of the computer network 518, an interface of the second load balancer 102b, or a combination thereof. The commands 512, 516 can cause one or more functional aspects of the first load balancer 102a and the second load balancer 102b to be reconfigured. For example, the commands 512, 516 can cause the settings or number of replicas of the load balancers 102a-b to be adjusted.

In the example shown in FIG. 5, the anomaly 508 is detected with respect to the first load balancer 102a, which is subsequently reconfigured to resolve the anomaly 508. But in other examples, the anomaly 508 may be detected with respect to a load balancer that is not reconfigured to resolve the anomaly 508; instead, a different load balancer may be reconfigured to resolve the anomaly 508. For example, consider the situation where there are three load balancers in the computer network 518. In this example, the first and second load balancers may be downstream of the third load balancer in a load balancing hierarchy. In this scenario, if an anomaly 508 is detected with respect to the first load balancer, it may be sufficient to adjust the settings of the second load balancer and/or the third load balancer to resolve the anomaly 508. The first load balancer may thus not need adjustment to resolve the anomaly 508.

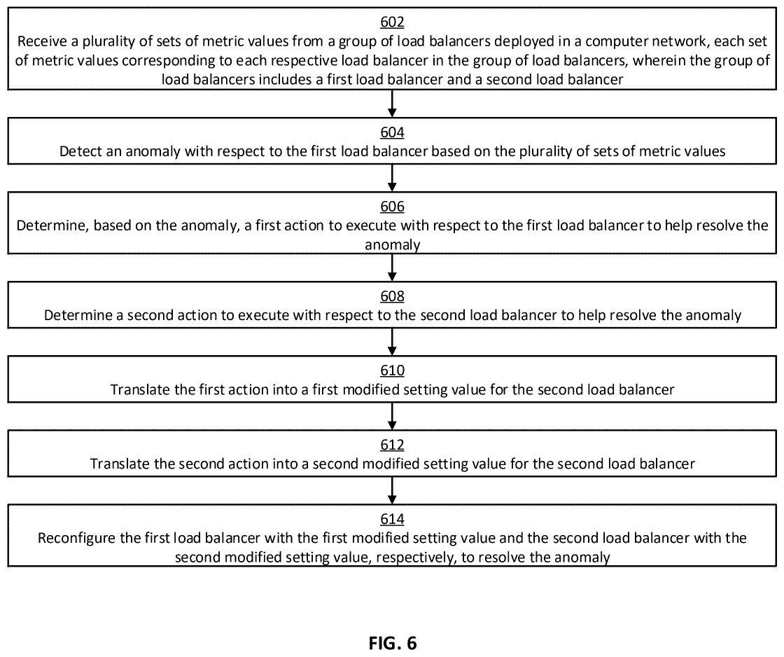

Turning now to FIG. 6, shown is a flowchart of an example of a process for automatically and dynamically coordinating load balancers in a computer network, according to some aspects of the present disclosure. Other examples may involve more operations, fewer operations, different operations, or a different sequence of operations than is shown. The operations of FIG. 6 are described below with reference to the components of FIG. 5 described above.

In block 602, the processor 502 receives a plurality of sets of metric values 520a-b from a group of load balancers 102a-b deployed in a computer network 518. Each set of metric values can correspond to a respective load balancer in the group of load balancers 120a-b. The group of load balancers 120a-b includes a first load balancer 120a and a second load balancer 120b.

In block 604, the processor 502 detects an anomaly 508 with respect to the first load balancer 102a based on the plurality of sets of metric values 520a-b. For example, the processor 502 can apply a first set of rules 120 and/or a trained machine-learning model to the plurality of sets of metric values 520a-b to detect the anomaly 508.

In block 606, the processor 502 determines, based on the anomaly 508, a first action 510 to execute with respect to the first load balancer 102a to help resolve the anomaly 508. For example, the processor 502 can apply a second set of rules 122 and/or a trained machine-learning model to the anomaly 508 to determine the first action 510.

In block 608, the processor 502 determines a second action 514 to execute with respect to the second load balancer 102b to help resolve the anomaly 508. The processor 502 can determine the second action 514 based on the first action 510, the anomaly 508, or both of these. For example, the processor 502 may select a second action 514 that is the inverse of the first action 510. If the first action 510 involves increasing a setting value for the first load balancer 102a by 10%, the second action 514 might involve decreasing the corresponding setting value for the second load balancer 102b by 10%. Alternatively, the second action 514 may mirror the first action 510. For instance, if the first action 510 increases a setting value for the first load balancer 102a by 15%, the second action 514 may similarly increase the corresponding setting value for the second load balancer 102b by 15%. In one such scenario, the second load balancer 102b may occupy a higher position in the load balancing hierarchy than the first load balancer 102a. In such a case, the first action 510 could involve increasing traffic flow to the first load balancer 102a by 15%. For this to occur, the second load balancer 102b may first need to be reconfigured to increase the traffic it directs to the first load balancer 102a by the same 15%. This ensures the first load balancer 102a receives sufficient traffic to achieve the desired adjustment.

In block 610, the processor 502 executes the first action 510 and the second action 514 to resolve the anomaly 508. This may involve transmitting a first set of commands to the load balancer 102a and a second set of commands to the load balancer 102b. The first set of commands can be different (e.g., in format, syntax, language, etc.) from the second set of commands. The first set of commands can include a first modified setting value, and the second set of commands can include a second modified setting value. The first set of commands and the second set of commands can cause the load balancer 102a-b to adjust their respective settings to match the first modified setting value and second modified setting value, respectively.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A non-transitory computer-readable medium comprising program code that is executable by one or more processors for causing the one or more processors to perform operations including:
receiving a plurality of sets of metric values from a group of load balancers deployed in a computer network, each set of metric values corresponding to a respective load balancer in the group of load balancers, wherein the group of load balancers includes a first load balancer and a second load balancer;
detecting an anomaly with respect to the first load balancer based on the plurality of sets of metric values;
determining, based on the anomaly, a first action to execute with respect to the first load balancer to help resolve the anomaly;
determining a second action to execute with respect to the second load balancer to help resolve the anomaly; and
executing the first action and the second action to resolve the anomaly.

2. The non-transitory computer-readable medium of claim 1, wherein the operations further comprise detecting the anomaly based on a first metric value from the first load balancer and a second metric value from the second load balancer.

3. The non-transitory computer-readable medium of claim 1, wherein executing the first action involves:
determining one or more commands based on the first action; and
transmitting the one or more commands to an interface to reconfigure the first load balancer.

4. The non-transitory computer-readable medium of claim 1, wherein the operations further comprise:
detecting the anomaly by applying a predefined set of rules to the plurality of sets of metric values;
determining the first action based on the anomaly by using a first predefined mapping of anomalies to actions;
determining a set of commands to execute based on the first action; and
executing the set of commands to implement the action.

5. The non-transitory computer-readable medium of claim 1, wherein executing the first action involves reconfiguring the first load balancer by executing a first plugin for the first load balancer, the first plugin being configured to communicate with the first load balancer via a first interface of the first load balancer using a first set of commands; and
wherein executing the second action involves reconfiguring the second load balancer by executing a second plugin for the second load balancer, the second plugin being configured to communicate with the second load balancer via a second interface of the second load balancer using a second set of commands, the second set of commands being different from the first set of commands.

6. The non-transitory computer-readable medium of claim 1, wherein the first load balancer is of a different type than the second load balancer.

7. The non-transitory computer-readable medium of claim 1, wherein the first load balancer and the second load balancer are in different hierarchical levels of the computer network.

8. A method comprising:
receiving, by one or more processors, a plurality of sets of metric values from a group of load balancers deployed in a computer network, each set of metric values corresponding to a respective load balancer in the group of load balancers, wherein the group of load balancers includes a first load balancer and a second load balancer;
detecting, by the one or more processors, an anomaly with respect to the first load balancer based on the plurality of sets of metric values;
determining, by the one or more processors and based on the anomaly, a first action to execute with respect to the first load balancer to help resolve the anomaly;
determining, by the one or more processors, a second action to execute with respect to the second load balancer to help resolve the anomaly; and
executing, by the one or more processors, the first action and the second action to resolve the anomaly.

9. The method of claim 8, further comprising:
detecting the anomaly based on a first metric value and a second metric value from at least two load balancers in the group of load balancers, wherein the first metric value corresponds to a first metric, and wherein the second metric value corresponds to a second metric that is different from the first metric.

10. The method of claim 8, further comprising:
determining one or more commands based on the first action; and
transmitting the one or more commands to an interface of the first load balancer to reconfigure the first load balancer in accordance with the one or more commands.

11. The method of claim 8, further comprising determining the first action and the second action by using a first predefined mapping of anomalies to actions.

12. The method of claim 8, wherein executing the first action involves reconfiguring the first load balancer by executing a first plugin for the first load balancer, the first plugin being configured to communicate with the first load balancer via a first interface of the first load balancer using a first set of commands; and
wherein executing the second action involves reconfiguring the second load balancer by executing a second plugin for the second load balancer, the second plugin being configured to communicate with the second load balancer via a second interface of the second load balancer using a second set of commands, the second set of commands being different from the first set of commands.

13. The method of claim 8, wherein the first load balancer is of the same type as the second load balancer.

14. The method of claim 8, wherein the first load balancer and the second load balancer are in the same hierarchical level of the computer network.

15. A system comprising:
one or more processors; and
one or more memories including instructions that are executable by the one or more processors for causing the one or more processors to perform operations including:
receiving a plurality of sets of metric values from a group of load balancers deployed in a computer network, each set of metric values corresponding to a respective load balancer in the group of load balancers, wherein the group of load balancers includes a first load balancer and a second load balancer;
detecting an anomaly with respect to the first load balancer based on the plurality of sets of metric values;
determining, based on the anomaly, a first action to execute with respect to the first load balancer to help resolve the anomaly;
determining a second action to execute with respect to the second load balancer to help resolve the anomaly; and
executing the first action and the second action to resolve the anomaly.

16. The system of claim 15, wherein the operations further comprise detecting the anomaly based on a combination of metric values from a combination of load balancers in the group of load balancers.

17. The system of claim 15, wherein the operations further comprise:
determining one or more commands based on the first action; and
transmitting the one or more commands to an interface of the first load balancer to adjust at least one setting of the first load balancer.

18. The system of claim 15, wherein the operations further comprise:
detecting the anomaly by applying a machine learning model to the plurality of sets of metric values; and
determining the first action based on the anomaly by using a first predefined mapping of anomalies to actions.

19. The system of claim 15, wherein executing the first action involves reconfiguring the first load balancer by executing a first plugin for the first load balancer, the first plugin being configured to communicate with the first load balancer via a first interface of the first load balancer using a first set of commands; and
wherein executing the second action involves reconfiguring the second load balancer by executing a second plugin for the second load balancer, the second plugin being different from the first plugin, and the second plugin being configured to communicate with the second load balancer via a second interface of the second load balancer using a second set of commands, the second set of commands being different from the first set of commands.

20. The system of claim 15, wherein the first load balancer is a parent or child with respect to the second load balancer in a load balancing hierarchy of the computer network.
